(19) United States
(12) Patent Application Publication
(10) Pub. No.: US 2004/0188493 A1
(43) Pub. Date: Sep. 30, 2004

(54) Fastening apparatus with bearing shoe and positioning plate

(76) Inventor: Patrick Herelier, Saint Jean de Muzols (FR)

Correspondence Address: LOWE, HAUPTMAN, GILMAN & BERNER, LLP (ITW), 1700 DIAGONAL ROAD, SUITE 300, ALEXANDRIA, VA, 22314, US

(21) Appl. No.: 10/762,554

(22) Filed: Jan. 23, 2004

(30) Foreign Application Priority Data
Jan. 23, 2003 (FR) 03 00723

(51) Int. Cl. B25C 7/00

(52) U.S. Cl. 227/142; 227/140

(57) ABSTRACT

The apparatus is intended to drive fasteners (21) for fastening a piece (20) to a support (30). The apparatus has a snout (12) equipped with a bearing shoe (14). The shoe is equipped with lateral positioning one-piece plate (15) on which there are formed a number of distinct lateral bearing surfaces (8, 8′, 8″, 8 82, 83) roughly parallel to the axis of the snout to be applied in particular to an edge of one of the pieces either the support piece or the piece that is to be fastened.

The invention relates to pneumatically-, gas- or powder-driven fastening apparatuses used in building work for driving fasteners and thus fastening a piece that is to be fastened onto a support piece. More particularly, the invention relates to staple guns with which, for example, cladding panels can be fastened.

It is increasingly frequent for this type of fastening to need to be performed precisely on the support and with a given length of penetration.

For that, the snouts of current fastening apparatuses are generally equipped with a bearing shoe used also for adjusting the axial penetration and the position of which can be adjusted parallel to the axis of the snout to allow the apparatus to be applied to the piece that is to be fastened via a bearing surface situated on one of its ends. However, while the fastening is thus made precise in terms of axial penetration of the fasteners, it remains imprecise in terms of the lateral position in a plane perpendicular to the axis of the snout.

Now, when the issue is one of fastening pieces via their edges onto supports which may in addition be of small surface area: beams, joists or other supports commonly used in building work, this position cannot remain approximate. This forces the workers using this type of apparatus to take greater care in their fastening work, and this leads to a loss of time.

Document U.S. Pat. No. 3,670,941 discloses a fastening apparatus of the type introduced hereinabove, comprising lateral positioning means, but with only one possible spacing.

Document FR 2 383 755 also discloses such an apparatus, with a lateral positioning screw which demands extremely fine adjustment.

The applicant company has set itself the task of proposing a fastening apparatus of the kind, introduced hereinabove, that is more flexible and easier to use.

Thus, the applicant company proposes a fastening apparatus of the above type comprising a snout equipped with a bearing shoe for adjusting the axial penetration of the fasteners along the axis of the snout, characterized in that the said shoe is equipped with a lateral positioning one-piece plate on which there are formed a number of distinct lateral bearing surfaces roughly parallel to the axis of the snout for being applied in ‘particular to an edge of one of the pieces, either the support piece or the piece that is to be fastened.

Thus, the bearing surfaces of the shoe and of the positioning plate forms square parts with which the plate that is to be fastened is positioned laterally and precisely without a loss of time.

As the lateral positioning plate is mounted on the shoe, the penetration can be adjusted without altering the lateral position adjustment, and vice versa.

As a preference, the lateral bearing surfaces of the positioning plate are formed at different distances from the axis of the snout and can be used independently of one another according to the positioning of the plate on the shoe.

Advantageously, the lateral bearing surfaces of the plate are circularly distributed on the lateral positioning plate and the plate is mounted so that it can turn and is held in place ‘under the action of the return means.

Advantageously too, the lateral positioning plate is fixed to the shoe by indexing on the bearing position of the bearing surfaces of the plate, and, as a preference, the indexing is achieved by clicking.

Advantageously still, the plate is designed to be able to be mounted turned over on itself on the shoe, which doubles the number of bearing surfaces that can be used per positioning plate.

In an advantageous embodiment of the apparatus of the invention, at least one stud is provided that functionally widens the lateral positioning plate.

The invention will be better understood with the aid of the following description, and of the accompanying drawing which:

FIG. 1 depicts an axial section through the fastening apparatus according to the invention,

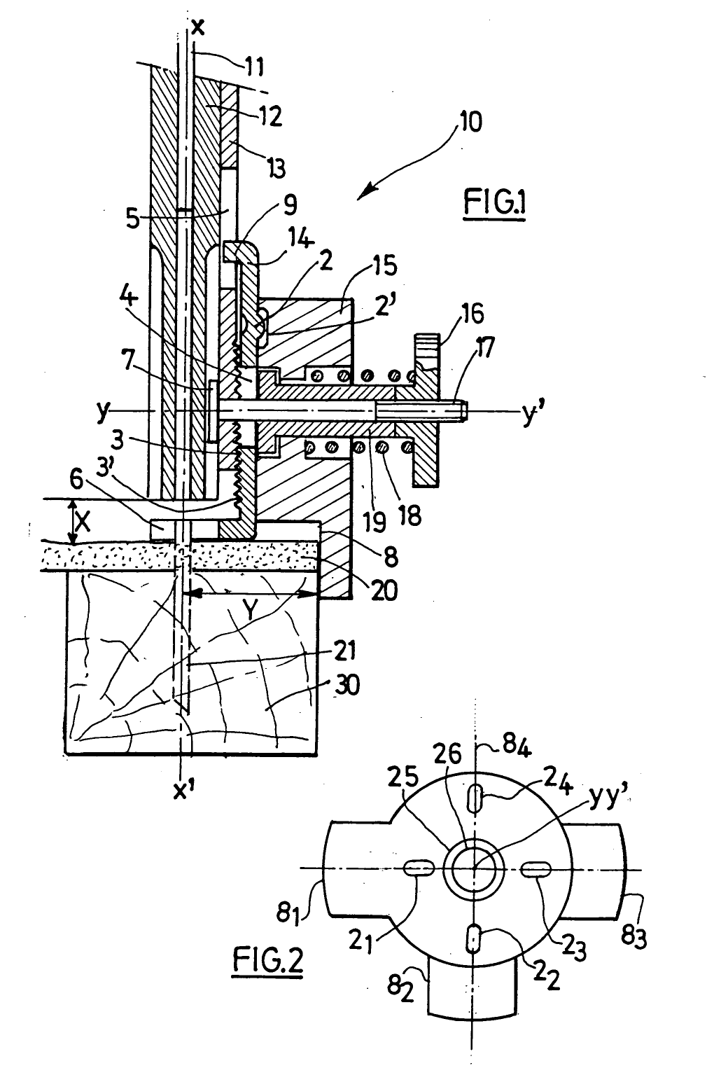

FIG. 2 depicts a plan view of the positioning plate,

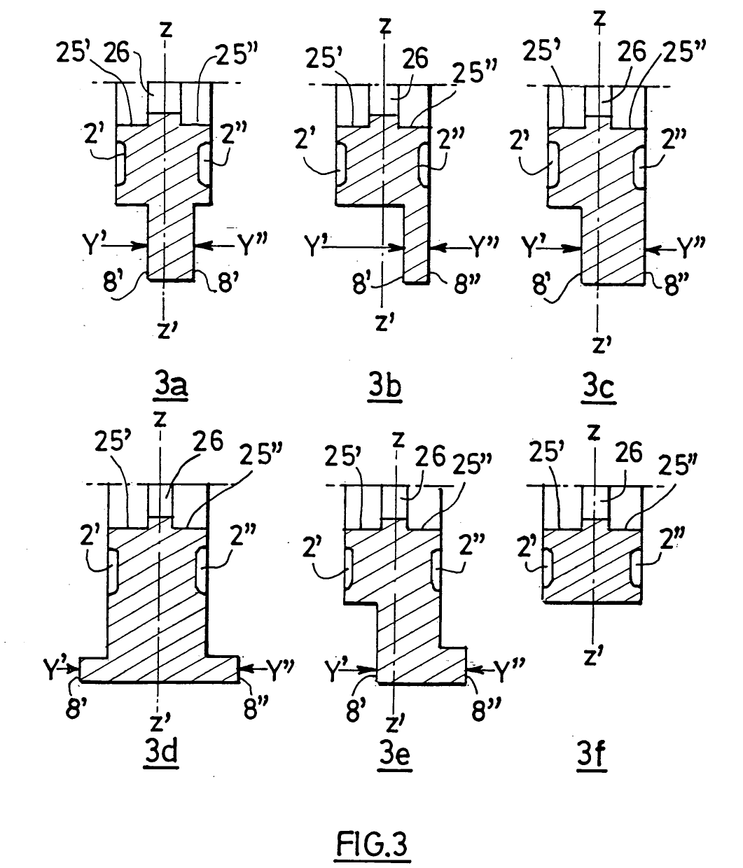

FIG. 3 depict sectional views of various possible bearing surfaces in the indexed position.

With reference to FIG. 1, the fastening apparatus 10 is made up of a snout 12 of axis xx′ in which there slides a piston 11 moved, for example, under the action of the pressure of a gas from a compressor, not depicted, to cause a fastener 21, for example a nail or a piton, from a supply magazine, also not depicted, to penetrate axially into the piece 20 that is to be fastened to a support 30. The snout supports an arming slideway 13 which is secured to it and which has a striated region 3 in which a striated region 3′ of a safety bearing shoe 14 can sit according to the positions for adjustment of the axial penetration of the fastener 21.

For this, the shoe 14 has a bearing surface 6 perpendicular to the axis xx′ to keep the end of the snout 12 a set distance X away from the piece that is to be fastened.

The set distance X. of the penetration is obtained by sliding the sloe along the slideway parallel to the axis xx′ by virtue of the holding afforded by a stud 9 of the shoe in a slot 5 of the slideway.

When the adjustment is obtained, the slideway 13 is clamped against the shoe 14 between the head 7 of a screw 17 of axis yy′ perpendicular to the axis xx′ and a nut i6• as the adjusting nut.

The striated regions 3 and 3′ nestle together and this secures the shoe and the slideway.

A slot 4 allows the screw 17 to pass through the shoe.

Here, a lateral positioning one-piece plate 15 designed to turn about the screw 17 and to be locked in its indexed positions i explained hereinafter, for which the plate, in the case of each one, presents a bearing surface 8 roughly parallel to the axis xx′, a distance Y from this axis, is inserted between the shoe and the adjusting nut.

Also inserted, in order to compensate for the thickness of the plate 15, is a ring 19, slipped freely over the screw, between the shoe and the nut. This ring which acts as a stop, allows the plate to rotate about the screw, merely under the pressure of a return spring 1.8 compressed onto the said plate by the adjusting nut.

With reference to FIG. 2, which depicts the plate 15 in plan view, the indexed positions i of the bearing surfaces 8, labelled 8i, in this instance 8₁ 8₂, 8₃, and a position 8₄ of absence of bearing surface are embodied by recesses, preferably, as here, oblong recesses, formed on the shoe on the bearing face, labelled 2₁, 2₂, 2₃, 2₄ and uniformly circularly distributed about the axis yy′ of the screw 17 or of the ring. 19 which pass through the plate at a hole 26. The positions are obtained in succession by turning the plate in such a way as to set a boss 2 provided on the shoe in one of the recesses, 2₁, 2₂, 2₃ or 2₄, which bossy is held there by clicking under the action of the spring 18.

The bearing surfaces 8₁, 8₂, 8₃ give different lateral distances Y₁, Y₂, Y₃ between the edge of the piece 20 that is to be fastened or of the support piece 30 and the axis xx′ of the axial penetration of the fastener.

Furthermore, a bore 25 houses the end of the spring 18.

With reference to FIG. 3, those labelled 3a to 3e, to each indexing recess 2′ on a bearing face 8′ of the plate there corresponds symmetrically a recess 2″ and a bearing face 8″ on the opposite face is of the plate, and to the bearing surface 8′ that allows the fastening to be performed at a lateral distance Y′ from the edge of the piece that is to be fastened there corresponds the bearing surface 8″ that allows this fastening to be performed at a lateral distance Y″ different from Y′.

Finally, as shown in FIG. 3a, a symmetric bore 25″, for housing the end of the spring 18, corresponds to the bore 25′.

Through these arrangements, the plate is designed to be mounted turned over on itself and is therefore reversible on the shoe so that it can be used on both faces.

FIGS. 3a, 3b, 3c, 3d, 3e thus show various possible settings for lateral distances Y offered by the various bearing surfaces of a positioning plate, turned over or otherwise.

In particular, FIGS. 3d and 3e show an advantageous embodiment of positioning plates, in which one of the bearing surfaces 8′ or 8″, or both in FIG. 3d, consist of a stud (8′ or 8″) that functionally widens the plate, allowing a reduction in the distance Y which can thus be shorter than the thickness of the apparatus consisting of the snout and shoe assembly.

Finally, FIG. 3f shows the configuration of the plate of FIG. 2 in half section on a plane passing through the axis yy′ and the recess 24 for which there is no bearing surface.

The fastening apparatus is adjusted in terms of axial and lateral position by performing the following operations:

1) the adjusting nut 16 is slackened,

2) the shoe 14 is slid along the arming slideway 13 to a position X corresponding to the desired axial penetration of the fastener 21,

3) the nut 16 is tightened onto the ring 19 to cause the striated regions 3, 3′ to nestle together and thus fix the shoe on the slideway,

4) the plate 15 is turned about the screw 17 to bring into position the bearing surface 8 that gives the desired lateral distance Y. The position is reached when the boss 2 is clicked into one of the recesses 2₁, 2₂, 2₃ or 2₄ corresponding to the bearing surface laterally distant from the axis xx′ of the snout of the apparatus by Y₁, Y₂, Y₃ or Y₄.

To turn the plate 15 over, the adjusting nut 16 is slackened, the plate is removed from the ring 19 and, the spring 18 being disengaged from the bore 25′, the plate is put back in place the other way up on the ring 19, the spring 18 is engaged in the bore 25″ symmetric with the bore 25′, and the adjusting nut 16 is tightened again.

1. Pneumatically-, gas- or powder-driven fastening apparatus for driving fasteners (21) and thus fastening a piece (20) that is to be fastened onto a support piece, comprising a snout (12) equipped with, a bearing shoe (14), characterized in that the said shoe is equipped with a lateral positioning one-piece plate (15) on which there are formed a number of distinct lateral bearing surfaces (8, 8′, 8″, 8 82, 83) roughly parallel, to the axis of the snout for being applied in particular to an edge of one of the pieces, either the support piece or the piece that is to be fastened.

2. Fastening apparatus according to claim 1, in which the lateral bearing surfaces (8, 8′, 8″) of the positioning plate (1.5) are formed. at different distances (Y, Y′, Y″) from the axis of the snout.

3. Fastening apparatus according to claim 2, in which the lateral bearing surfaces of the plate are circularly distributed (8k, 82, 83) on the lateral positioning plate, the plate being mounted so that it canturn and being held in. place under the action of the return means (16, 17, 18).

4. Fastening apparatus according to claim 2, in which the lateral positioning plate is fixed to the shoe by indexing (2, 2′, 2″, 2 22, 23, 24) on the bearing position of the bearing surfaces of the plate.

5. Fastening apparatus according to claim 4, in which the indexing is achieved by clicking (18, 2, 2′).

6. Fastening apparatus according to claim 1, in which the plate is designed to be able to be mounted turned over on itself (25′, 25″, Y′, Y″, 2′, 2″) on the shoe.

7. Fastening apparatus according to claim 1, in which (3d, 3e) there is provided at least one stud (8′, 8″) that functionally widens the lateral positioning plate.

8. Fastening apparatus according to claim 1, in which the bearing shoe (14) is a shoe for adjusting the axial penetration of the fasteners along the axis x, x′ of the snout.
